(19) United States
(12) Patent Application Publication
(10) Pub. No.: US 2016/0379416 A1
(43) Pub. Date: Dec. 29, 2016

(54) APPARATUS AND METHOD FOR CONTROLLING OBJECT MOVEMENT

(71) Applicant: Samsung Electronics Co., Ltd., Gyeonggi-do (KR)

(72) Inventors: An-na PARK, Gyeonggi-do (KR); Byung-jun SON, Seoul (KR); Sung-joo AHN, Seoul (KR); Hyun-guk YOO, Gyeonggi-do (KR); Ga-hyun JOO, Gyeonggi-do (KR)

(21) Appl. No.: 15/196,860

(22) Filed: Jun. 29, 2016

(30) Foreign Application Priority Data
Jun. 29, 2015 (KR) 10-2015-0091934

(51) Int. Cl. G06T 19/00; G06T 7/20; G09G 5/00; G06T 7/00

(52) U.S. Cl. CPC G06T 19/006; G06T 7/004; G06T 7/20; G09G 5/003

(57) ABSTRACT

Methods and apparatuses are provided for controlling movement of a first object. A screen photographed by a camera is displayed on a display of an electronic device. A virtual area is set on the screen based on user input. A first object is identified on the screen. The first object is controlled to move within the virtual area.

### PRIORITY

This application claims priority under 35 U.S.C. §119(a) to Korean Patent Application No. 10-2015-0091934, filed in the Korean Intellectual Property Office on Jun. 29, 2015, the content of which is incorporated herein by reference.

### BACKGROUND

1. Field of the Disclosure

The present disclosure relates generally to a method and an apparatus for controlling object motion, and more particularly, to a method and an apparatus that identifies a moving object on a screen photographed by a camera, sets an area to restrict movement of the object on the photographed screen, and controls the object to move only within a set area.

2. Description of the Related Art

In order for pets to be monitored while they are alone in a house, and in an effort to induce pet movement, automatically moving devices have been developed. However, since these devices operate independently, their use without user monitoring or control may be uncomfortable for a user.

### SUMMARY

An aspect of the present disclosure provides a method and an apparatus that controls operations of an object through user settings and monitors movements of the object on a real-time basis.

According to an embodiment of the present disclosure, an electronic device is provided that includes a display configured to display a screen photographed by a camera. The electronic device also includes a controller configured to receive a user input, set a virtual area on the screen based on the user input, identify a first object on the screen, and control the first object to move within the virtual area.

According to another embodiment of the present disclosure, a method is provided for controlling movement of a first object. A screen photographed by a camera is displayed on a display of an electronic device. A virtual area is set on the screen based on user input. A first object is identified on the screen. The first object is controlled to move within the virtual area.

According to an embodiment of the present disclosure, an electronic device is provided that includes a camera and a controller configured to analyze a screen photographed by the camera, determine a virtual area on the screen, identify a first object on the screen, and control the first object to move within the virtual area.

### BRIEF DESCRIPTION OF THE DRAWINGS

The above and/or other aspects, features, and advantages of the present disclosure will be more apparent from the following detailed description when taken in conjunction with the accompanying drawings, in which:

FIG. 1 is a diagram illustrating an electronic device and a peripheral device, according to an embodiment of the present disclosure;

FIGS. 2A to 2C are diagrams illustrating the electronic device, a first device, and a first object, according to an embodiment of the present disclosure;

FIGS. 3A and 3B are flowcharts illustrating a process for controlling a first object in the electronic device, according to an embodiment of the present disclosure;

FIG. 4 is a diagram illustrating the setting of a virtual area on a screen photographed by a camera using the first device and controlling movement of the first object, according to an embodiment of the present disclosure;

FIGS. 5A to 5E are diagrams illustrating the setting of a virtual area on a screen displayed on a display of the electronic device or the first device, according to an embodiment of the present disclosure;

FIG. 6 is a flowchart illustrating a process for setting a virtual area in the electronic device and controlling movement of a first object, according to an embodiment of the present disclosure;

FIG. 7 is a diagram illustrating identification of a first object on a screen photographed by a camera and movement of the first object according to a user input, according to an embodiment of the present disclosure;

FIG. 8 is a diagram illustrating identification of a first object on a screen photographed by a camera and movement of the first object according to a user input, according to an embodiment of the present disclosure;

FIG. 9 is a diagram illustrating the display of a notification in the electronic device when a first object or a second object is out of a setting area on a screen photographed by a camera, according to an embodiment of the present disclosure;

FIG. 10 is a diagram illustrating surveillance in a parking lot, according to an embodiment of the present disclosure;

FIG. 11 is a diagram illustrating surveillance in a parking lot, according to another embodiment of the present disclosure;

FIG. 12 is a diagram illustrating surveillance, according to an embodiment of the present disclosure; and

FIG. 13 is a diagram illustrating surveillance, according to an embodiment of the present disclosure.

### DETAILED DESCRIPTION

Embodiments of the present disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

In the present disclosure, relational terms such as first and second, and the like, may be used to distinguish one entity from another, without necessarily implying any actual relationship or order between such entities.

The terms used herein are provided to describe specific embodiments and are not intended to limit the scope of an inventive concept. A singular term includes a plural form unless clearly defined otherwise. The terms “include” and “configured to”, as used herein, are used to indicate that there are features, numbers, steps, operations, elements, parts or a combination thereof, and these terms should not exclude the possibility of a combination or an addition of one or more features, numbers, steps, operations, elements, parts, or a combination thereof.

As described herein, a module or a unit may perform at least one function or operation, and may be realized as hardware, software, or a combination thereof. In addition, a plurality of modules or units may be integrated into at least one module and may be realized as at least one process, except for modules or units that should be realized in specific hardware. When one element is referred to as being “connected to” another element, the elements may be directly connected or a third element may be connected in between. When an element is referred to as being “directly connected to” another element, the elements are directly connected without a third element connected in between.

Herein, the expression “configured to” can be used interchangeably with, for example, “suitable for”, “having the capacity to”, “designed to”, “adapted to”, “made to”, or “capable of”. The expression “configured to” does not necessarily mean “specifically designed to” in a hardware sense. Instead, under some circumstances, “a device configured to” may indicate that such a device can perform an operation along with another device or part. For example, the expression “a processor configured to perform A, B, and C” may indicate an exclusive processor (e.g., an embedded processor) to perform the corresponding operation, or a generic-purpose processor (e.g., a central processing unit (CPU) or application processor (AP)) that can perform the corresponding operations by executing one or more software programs stored in the memory device.

Technical terms used herein are to be used for the purpose of describing particular embodiments only, and are not intended to limit the present invention. In addition, the technical terms used herein are to be interpreted as is understood in the present specification by those of ordinary skill in the art, unless they are specifically defined by other means. Further, when technical terms do not accurately represent the features of the present disclosure, they may be replaced with meanings determined by one of ordinary skill in the art. In addition, the general terms used herein, which are defined as provided in advance, or which are to be interpreted according to the context before and after, are not to be construed as having a meaning in an excessively reduced manner.

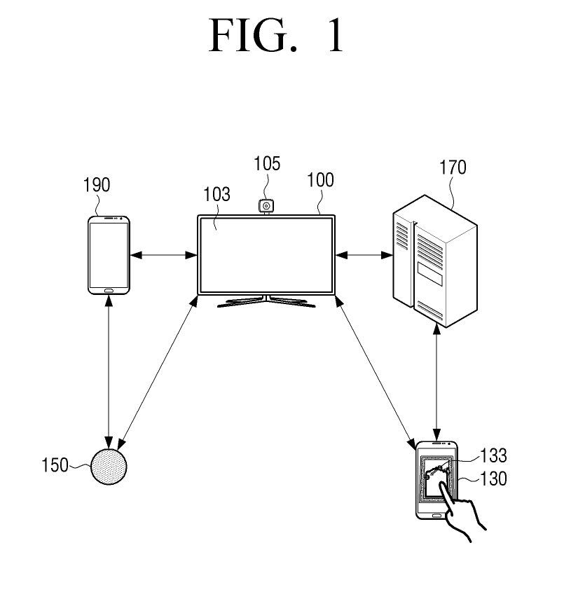

FIG. 1 is a diagram illustrating an electronic device and a peripheral device, according to an embodiment of the present disclosure. FIG. 1 illustrates an electronic device 100, a server 170, a first device 130, a second device 190, and a first object 150.

The electronic device 100 may be embodied as a smartphone, a tablet personal computer, a mobile phone, a desktop personal computer, a laptop personal computer, or a TV. The electronic device 100 includes a camera 105 or may be connected to the camera 105 with wire or wirelessly through an input/output interface.

The camera 105 may be embedded inside the electronic device 100 or provided as a separate accessory and exist outside the electronic device, and can be electrically connected to the electronic device.

The camera 105 may output a video signal by photographing the first object 150. The electronic device 100 may receive the video signal that is output from the camera 105, and display the same on a display 103. The display 103 may be a touch screen, and a user may set a virtual area on a screen displayed on a touch screen.

The electronic device 100 may receive a user input to set a virtual area and store a coordinate on a screen corresponding to the virtual area. The electronic device 100 may include a communicator, and may receive/transmit data wirelessly or with wire with the first object 150, the first device 130, and the server 170 through the communicator. In addition, the electronic device 100 can receive and transmit data with the second device 190 through an input/output interface.

In addition, the electronic device 100 may analyze a screen photographed by the camera 105 and set a virtual area without displaying the video signal output from the camera on the display, identify the first object 150 which moves on a screen, and control the first object 150 so that the first object 150 moves only in a virtual area. The video signal which is output from the camera can be digital data. In addition, the electronic device may analyze a screen photographed by the camera 105 and determine a position of the first object 150. Analyzing the photographed screen refers to analyzing video data constituting the screen.

The server 170 may play a brokerage role between the electronic device 100 and the first device 130. The server 170 may transmit or receive data, wirelessly or with wire, to or from the electronic device 100. For example, the server 170 may be connected with the electronic device 100 with wire, and may transmit/receive data. In addition, the server 170 may transmit/receive data, with wire or wirelessly, with the first device 130. The server 170 may receive data from the electronic device 100 and send the data to the first device 130, and the server 170 may receive data from the first device 130 and send the data to the electronic device 100. In addition, the first device 130 may directly transmit data to the first device 130 without the server 170.

The first device 130 may be embodied as, for example, a mobile device such as a smart phone. The first device 130 may transmit/receive data to/from the electronic device 100 via the server 170. In addition, the first device 130 may directly transmit/receive data to/from the electronic device 100. For example, the first device 130 may directly transmit/receive data to/from electronic device 100 via long term evolution (LTE) communication.

The first object 150 is a device that includes a driver (e.g., wheels operated by a motor) and can move by itself. The first object may be, for example, in the shape of a ball. The first object may include a communicator, and may transmit/receive data to/from the electronic device 100, the first device 130, and the second device 190. In addition, the first object 150 may include a sensor, and the position of the first object 150 can be changed by a signal output from the sensor. In addition, the position of the first object 150 can move in response to data received from the electronic device 100 or from the first device 130.

The second device 190 may be a wireless dongle. For example, the second device 190 may include a Wi-Fi module, a Bluetooth module, or an infrared module. If the electronic device 100 has no wireless communication function, the electronic device 100 may be wirelessly connected with an external device through the second device 190. The second device 190 may receive data from the first object 150, send the data to the electronic device 100, or the second device 190 may receive data from electronic device 100 and send the data to the first object 150.

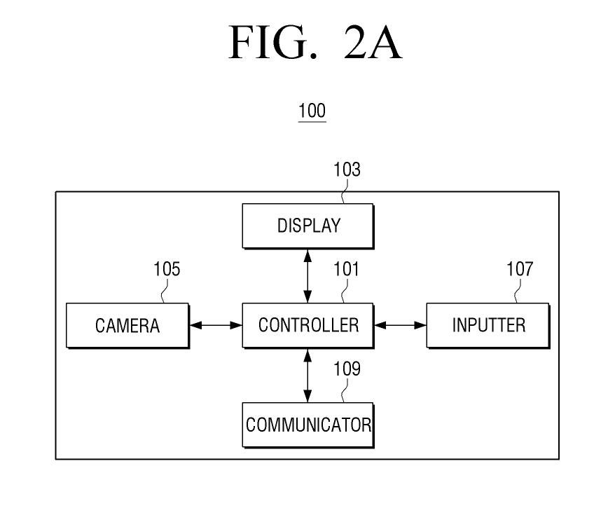

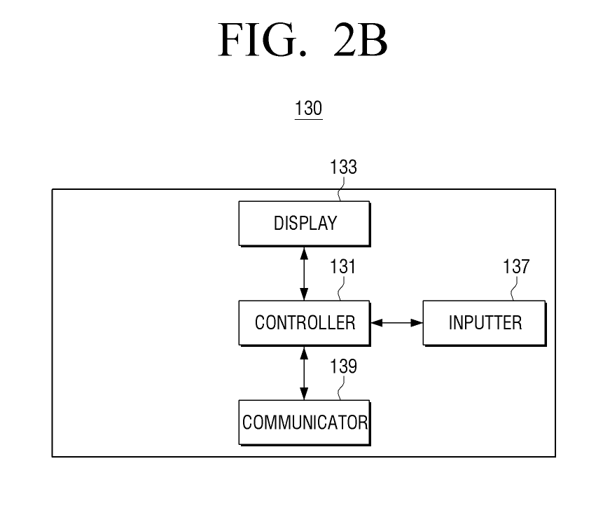

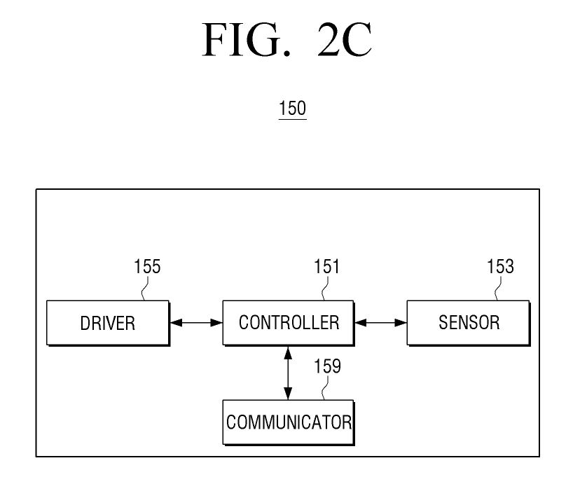

FIGS. 2A to 2C are block diagrams illustrating the electronic device, the first device, and the first object, according to an embodiment of the present disclosure.

Referring to FIG. 2A, a block diagram of the electronic device 100 is illustrated. The electronic device 100 includes a controller 101, the camera 105, the display 103, an inputter 107, and a communicator 109.

The controller 101 may control the overall operations of the electronic device 100, control signal flow among internal elements of the electronic device 100, and process data.

The camera 105 may photograph an object and output a video signal. In addition, the camera 105 is capable of zooming, panning, and tilting, and may track the object using the controller 101. An object photographed by the camera 105 may include a driver, and may be the first object 150 which can move by itself. The object photographed by the camera may instead be a second object that can be a baby or a pet that is in a photographing area. The camera 105 may be implemented as an all-in-one type or a separated type. When the camera 105 is implemented as a separated type, the camera can be electrically connected with the electronic device 100 through the communicator 109 or input interface.

The inputter 107, for example, may include a touch panel, a digital pen sensor, a key, or an ultrasonic input device. The touch panel, for example, may use one of the capacitive, reducing, infrared, or ultrasonic method. In addition, a touch panel may further include a control circuit. The touch panel further includes a tactile layer, and it is possible to provide tactile response to the user. The digital pen sensor may, for example, be a part of a touch panel, or may include other recognition sheets. The key, for example, may include a physical button, an optical key, or keypad. The ultrasonic input device may detect ultrasonic waves generated by an input tool, via a microphone, and may check the data corresponding to the detected ultrasonic waves. A user may set the virtual area on the screen via the input unit 107.

The display 103 can display an image captured through the camera 105 on the screen. The display 103 may include a display panel and a control circuit for controlling the display panel. The display panel, for example, may include a liquid crystal display (LCD), a light-emitting diode (LED) display, an organic light-emitting diode (OLED) display, a microelectromechanical systems (MEMS), or an electronic paper.

The display 103 may include a portion of the inputter 107. For example, the display 103 may include a touch panel, and may be a touch screen configured as a touch panel and a module. The touch screen may receive a touch, a gesture, a proximity input, or a hovering input by using a stylus or a part of the user's body.

The communicator 109, for example, may set up communication between the electronic device 100 and the first object 150 (for example, a subject). The communicator 109 may communicate with the first object 150 or the server 170 via wireless communication or wired communication. The first object 150 may be photographed by the camera 105 or may be a subject. The electronic device may determine a position of the first object based on signals received from the first object.

Wireless communication is a cellular communication protocol and may use, for example, at least one of LTE, LTE-advanced (LTE-A), code division multiple access (CDMA), wideband CDMA (WCDMA), universal mobile telecommunications system (UMTS), wireless broadband (WiBro), or global system for mobile communications (GSM). In addition, wireless communication, for example, may include short distance communication. Short distance communication may, for example, include at least one of WiFi, Bluetooth, or near field communication (NFC).

Wired communication may, for example, include at least one of universal serial bus (USB), high definition multimedia interface (HDMI), recommended standard-232 (RS-232), or plain old telephone service (POTS). The network may include, for example, a telecommunications network, a computer network (e.g. a local area network (LAN) or a wide area network (WAN)), Internet, or a telephone network.

The electronic device 100 may display a screen that has been picked up by the camera 105 on the display 103, receive a user input on the screen displayed on the display 103, set up a virtual area on the screen based on the input of the user, identify the first object 150 to be moved on the screen, and control the first object 150 so that it moves only in the virtual area. Specifically, when the first object 150 exists outside of the virtual area, the controller 101 may transmit the data controlling the first object 150 to the first object 150, and control the first object 150 to move inside of the virtual area.

In addition, the controller 101 may identify a second object, and when the second object is out of the virtual area, a notification can be provided. The notification can be a text message, voice message, or vibration feedback.

FIG. 2B is a block diagram illustrating the first device 130, which includes a controller 131, the display 133, a communicator 139, and an inputter 137. The first device 130, for example, may be a mobile device such as a smart phone.

The controller 131 may control overall operations of the first device 130 and signal flow among internal elements of the first device 130, and process data received from the electronic device 100 or the server 170.

The display 133 may be a touch screen, and may display data received from the electronic device 100 or the server 170 on a screen through the control of the controller 131.

The communicator 139 may perform wired or wireless communication with the electronic device 100, the server 170, and the first object 150, and may receive/transmit data. The communicator 139 may provide short distance wireless communication and long distance wireless communication.

The inputter 137, for example, may include at least one of a touch panel, a touch pen, and a key button, and may be used to input data to the first device 130. A portion of the input unit 137 can be configured integrally with the display unit 133. For example, the touch screen has both input functions and display functions.

The user can utilize the first device to remotely monitor the image captured by the camera 105 of the electronic device 100, and to set a virtual area from the display 133 of the first device 130. When a user sets up a virtual area on a screen displayed on the display 133 of the first device 130 by using a pen, the first device 130 detects a touch on the screen, and sends coordinate information of the touched point to the electronic device 100. The electronic device 100 may set the virtual area from the imaging region of the camera 105 based on the coordinate information of the touch point received from the first device 130. That is, the electronic device 100 may transmit the images captured by the camera 105 to the first device 130, and based on the coordinate information of the touch point received from the first device 130, may set a virtual area.

If the virtual area is set, the electronic device 100 may determine whether the first object 150 exists within the virtual area, and may control the first object 150 to move within the virtual area. If the first object 150 leaves the virtual area, the electronic device 100 can control the first object 150 so that the first object 150 is moved into the virtual area.

Further, the first device 130 can transmit and receive data by communicating directly with the electronic device 100 and the first object 150. The controller 131 may control the display 133 to display the image data received from the electronic device 100 on the screen. Further, the controller 131 may receive the user input to move the first object 150 from the display 133, and based on the user input, control the communicator 139 to transmit the data to the electronic device 100 to control the movement of the first object 150. Alternatively, the controller 131 may receive the user input to move the first object 150 from the display 133, and based on user input, may control the movement of the first object 150. Specifically, the controller 131 may transmit the control signal for controlling the first object 150 to the first object 150, based on a user input.

Referring to FIG. 2C, a block diagram illustrates the first object 150, which includes the controller 151, the driver 155, the sensor 153, and the communicator 159.

The controller 151 may control the driver 155 based on data received from the electronic device 100 or data received from the sensor 153. For example, when a human or a pet approaches to the first object 150, the controller may detect the approach via a proximity sensor, and may control the driving unit 155 to move the first object 150. The controller 151 may receive information of the virtual area from the electronic device 100, and control the driver 155 so that the first object 150 is within the virtual area. That is, the controller 151 may control driver 155 based on a signal received from the sensor 153 and a signal received from the electronic device 100.

The driver 155 may include, for example, a motor and wheels. The driver 155 may move the first object 150 through the control of the controller 151.

The sensor 153 may include, for example, an acceleration sensor, a gyro sensor, and a proximity sensor. The controller 151 may determine the position of the first object 150 based on a signal output from the sensor 153, and transmit the location information of the first object 150 to the electronic device 100. The electronic device 100 can determine whether the first object 150 exists in the virtual area based on the position information received from the first object 150.

The communicator 159 may be embodied for proximity communication such as Wi-Fi, Bluetooth, or infrared communication. The communicator 159 may communicate with the electronic device 100, the first device 130, and second device 190, and can transmit and receive data. The communicator may transmit the position information of the first object 150 to the electronic device 100, the first device 130, and the second device 190. The communicator 159 can receive the data from the electronic device 100, the first device 130, and second device 190.

The first object 150 may include a GPS receiver. The controller 151 may determine a position of the first object 150 based on the data received from the GPS receiver, and may transmit the position information of the first object 150 to the electronic device 100. The electronic device 100 may determine whether the first object 150 exists in the virtual area based on the location information received from the first object 150.

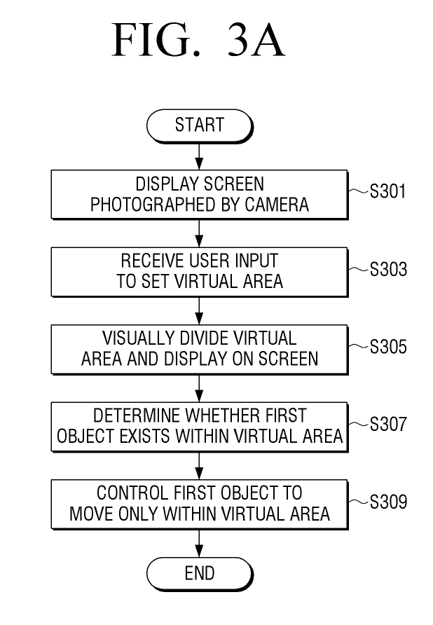

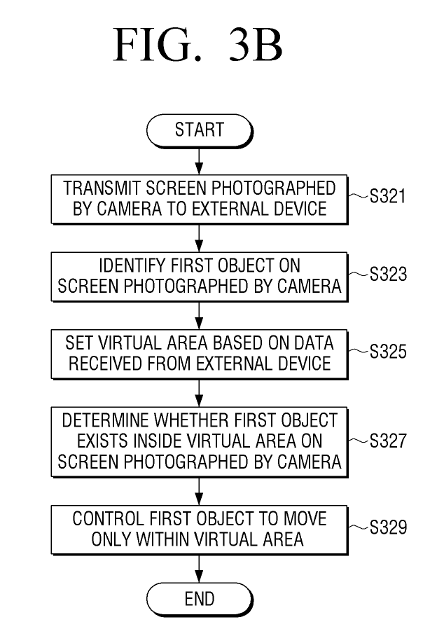

FIGS. 3A and 3B are flowcharts illustrating a process for controlling a first object in the electronic device, according to an embodiment of the present disclosure.

Referring to FIG. 3A, the electronic device 100 displays a screen captured by the camera 105 on the display 103, in step S301. The camera 105 may capture the first object 150 and the second object, and output a video signal corresponding to the captured screen.

The controller 101 may control the display 103 so as to receive a video signal and display the captured screen. The controller 101 may identify the first object 150 on the screen. The controller 101 may identify the first object 150 based on identification information of the first object 150 that is transmitted from the first object 150. The controller 101 may control the communicator 190 to receive identification information from the first object 150 and transmit the data to move the first object 150. The first object 150 may receive data and move its position based on the data. When movement of the first object 150 is detected on a screen captured by the camera 105, the controller 101 may identify the first object 150 on a screen based on the movement information of the first object 150. The controller 101 may store position information of the first object 150 identified on a screen. The position information of the first object 150 may be a coordinate value on a screen.

The electronic device 100 receives the user input to set a virtual area on the screen, in step S303, and displays the virtual area on the screen by separating the virtual zone from the remaining area on the screen, in step S305. For example, the controller 101 can control the display 103 to display a boundary corresponding to a virtual area on the screen.

In addition, the electronic device 100 may, set the virtual area, without displaying a screen captured by the camera 105, by analyzing the captured screen in the camera, and may identify the first object moving only within the virtual area. The electronic device may analyze the captured screen and set a virtual area without user input based on the analysis results. The electronic device 100 determines whether the first object 150 exists within a virtual area, in step S307.

Specifically, the controller 101 may determine a coordinate value for the current position of the first object 150 and whether the first object 150 is within the virtual area, based on the position information of the first object 150 that is received from the first object 150. Further, the controller 101 may analyze the captured screen in the camera 105 to determine the on-screen position of the first object 150, and may determine whether the first object 150 exists in the virtual area.

The electronic device 100 controls the first object 150 so that the first object 150 is moved within the virtual area, in step S309. Specifically, the controller 101 may move the first object based on virtual area setting information and position information of the first object 150. When the first object 150 is determined to be outside of the virtual area, the controller 101 may control the first object to move within the virtual area. The controller 101 can control the communicator 109 to send a command to move the first object 150 to the first object 150. A movement command may be coordinate data representing the new position of the first object 150, and the first object 150 may be moved to the position based on the coordinate data received from the electronic device 100.

Referring to FIG. 3B, the electronic device 100 transmits the captured screen in the camera 105 to an external device, in step S321. The external device may be the server 170 or the first device 130. The first device 130 may be a smart phone with a built-in touch screen. In addition, the electronic device 100 may display a captured screen from the camera 105 on the display 103.

If the external device is the server 170, the server 170 may receive a screen captured by the camera 105, display the received screen on a monitor connected to the server 170, or retransmit the screen to another connected device. The other device may be a smartphone. The server 170 may directly receive virtual area setting data from a user, or may receive virtual area setting data from another device. The device 170 transmits virtual area setting data to the electronic device.

The electronic device 100 identifies the first object 150 on a screen captured in the camera, in step S323. The controller 101 may identify the first object 150 in the captured screen by analyzing the captured screen in the camera 105. The controller may analyze the captured image and detect the movement of the first object. The controller 101 may identify the first object 150 based on the ID information of the first object 150 sent from the first object 150. The controller 101 may receive ID information from the first object 150 and transmit data to move the first object 150 to the first object 150.

When a movement of the first object 150 is detected on the screen captured by the camera 105, the controller 101 may identify the first object 150 on the screen based on the movement information of the first object 150. The controller 101 may store the location information of the first object 150 identified on the screen. Location information of the first object 150 may be a value in terms of coordinates on the screen. The electronic device 100 sets the virtual area based on the data received from the external device, in step S325. An external device may be the server 170 or the first device 130. The data received from the external device may be coordinate information on the virtual area.

The electronic device 100 determines whether the first object 150 exists inside the virtual area, in step S327. The controller 101 may determine a coordinate value of the current location of the first object 150 based on the location information of the first object 150, and determine whether the first object 150 exists within the virtual area. Further, the controller 101 may analyze the captured screen in the camera 105 to determine the on-screen position of the first object 150, and may determine whether the first object 150 exists in the virtual area. The electronic device 100 controls the first object 150 so that the first object 150 moves within the virtual area, in step S329. Specifically, the controller 101 may move the first object based on virtual area setting information and first object position information. When it is determined that the first object 150 is outside of the virtual area, the controller 101 may control the first object 150 to move within the virtual area.

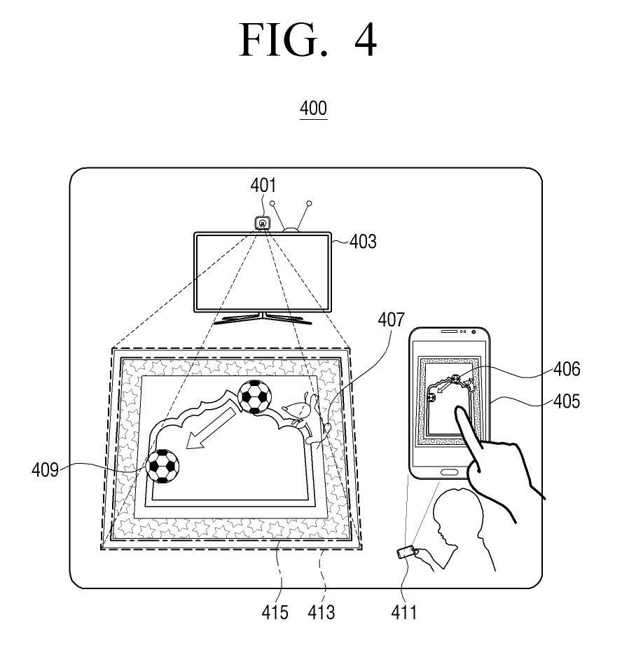

FIG. 4 is a diagram illustrating setting a virtual area on a screen photographed by a camera using the first device and controlling movement of the first object, according to an embodiment of the present disclosure. FIG. 4 illustrates a camera 401, an electronic device 403, a first device 405, a first object 409, a second object 407, a photographing area 413, and a virtual area 415.

The camera 401 may be built into the electronic device 403 or may be connected to electronic device 403 via wired or wireless communication. The electronic device 403 may be a TV. A screen captured by the camera 401 may be displayed on the display of the electronic device 403 or may be transmitted to the first device 405. In addition, if a communication function is built in the camera 401, the camera 401 can directly transmit a captured screen to the first device 405.

If the camera 401 does not have a communication function, the captured image can be transmitted to the first device 405 through the electronic device 403. The first device 405 may be a smart phone. The first device 405 may receive a screen captured by the camera 401, and may display the received screen on a touch screen 406. The first device 405 may receive a user input to set the virtual area 415 on the touch screen 406, and may transmit a signal corresponding to the user input to the electronic device 403. The electronic device 403 may set the virtual area 415 based on a signal received from the first device 405. The signal received from the first device 405 can be coordinate information for setting the virtual area 415. The information on the virtual area 415 received from the first device 405 can be stored in the electronic device 403.

The electronic device 403 may monitor a movement of the first object 409 and the second object 407 on a screen photographed by the camera 401. The first object 409 may autonomously move using a driver. The first object 409 may transfer position information to the electronic device 403, and the electronic device 403, may determine whether the first object 409 is inside the virtual area 415 based on a signal received from the first object 409. Alternatively, the electronic device 403 may analyze a screen photographed by the camera 401 to detect movement of the first object 409, and determine whether the first object 409 is inside the virtual area 415. When the first object 409 is outside of the virtual area, the electronic device 403 may control the first object 409 so that the first object 409 moves into the virtual area 415. The electronic device 403 may transfer information on a random position inside the virtual area 415 to the first object 409, and the first object 409 may move based on position information received from the electronic device 403. Additionally, the first object 409 may include a sensor, and the first object 409 may control movement of the first object 409 based on a signal outputted from the sensor.

For example, the first object 409 may include a proximity sensor, and when the second object 407 approaches to the first object 409, a signal can be output from the proximity sensor. The first object 409 may control a driver to move the first object 409 according to the signal output from the proximity sensor. The movable scope of the first object 409 may be limited to the inside of the virtual area. The first object 409 may have information on the virtual area, and control a driver based on the virtual area. Alternatively, the first object 409 may move without information on the virtual area, and determine whether the first object 409 exists inside the virtual area, by transmitting position information to the electronic device 403 on a real-time basis. When the first object 409 is outside of the setting area, the electronic device 403 may control the first object 409 to move the first object 409 into the virtual area.

The electronic device 403, on a screen displayed on the display, may move the first object 409 based on a user input to designate a position of the first object 409. Additionally, the electronic device 403 may move the first object 409 based on a signal received from the first device 405. For example, when a user designates a moving position of the first object 409 on a display displayed on the display of the electronic device 403, the electronic device 403 may control the first object 409 to move to the above position. When a user designates a position of the first object 409 on a screen displayed on the first device 405, the electronic device 403 may receive position information from the first object 409 via the server 170 or directly from the first device 405, or control the first object 409 to move the first object 409 based on position information of the received first object 409. The photographing area 413 is photographed by the camera, and may be a screen displayed on the display.

The virtual area 415 is set on a screen photographed by a user input. The virtual area 415 may be smaller than or equal to a photographing area. The electronic device 403 may detect a user input on a screen displayed on a display and set the virtual area 415 based on the user input. In addition, the electronic device 403 may set the virtual area 415 based on data received from an external device. The external device may be the server 170 or the first device 405. When the virtual area 415 is set, a border line of the virtual area 415 may be displayed on a screen, or the virtual area 415 may be displayed to be visually distinctive.

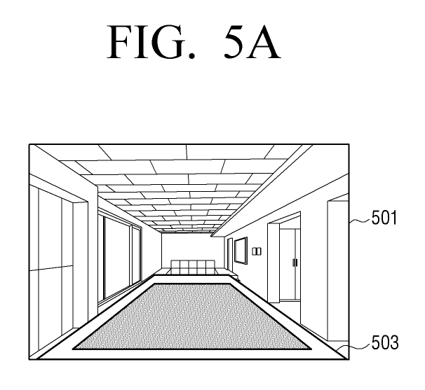

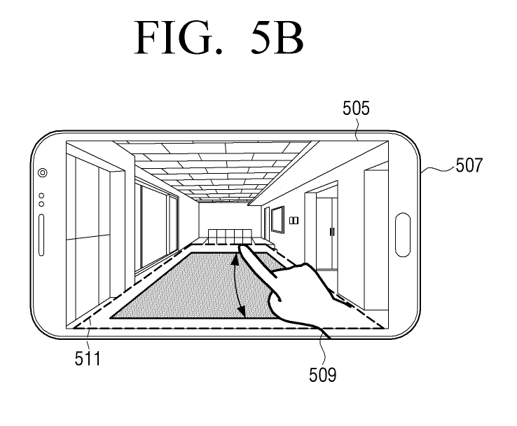

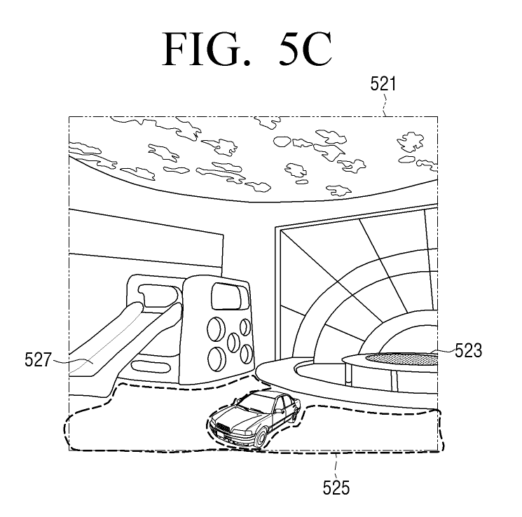

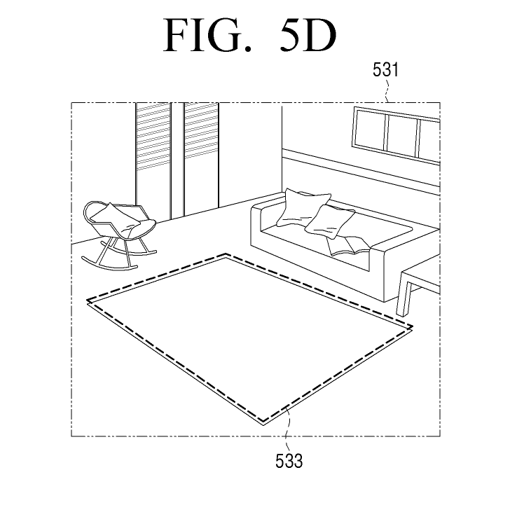

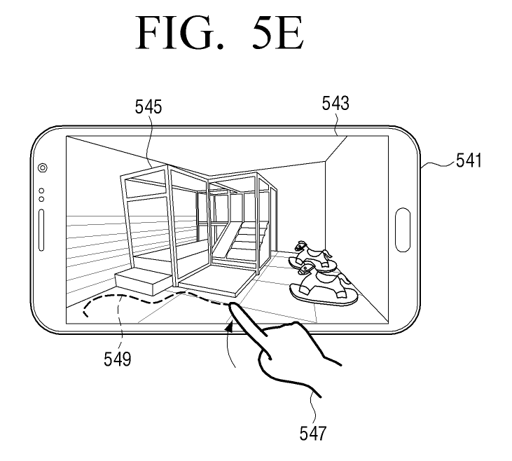

FIGS. 5A to 5E are diagrams illustrating the setting of a virtual area on a screen displayed on a display of the electronic device or the first device, according to an embodiment of the present disclosure.

Referring to FIG. 5A, a photographing area 501 and a virtual area 503 are illustrated. On the photographed screen, when a user inputs a percentage of the entire photographing area 501 to which a virtual area is to be set, the electronic device 403 may automatically set an area corresponding to the input number as the virtual area 503. For example, when a user inputs 80 on a photographed screen, an area corresponding to 80% of the entire photographing area 501 is set as the virtual area 503, and on the screen, a border line of the virtual area 503 may be displayed or the virtual area 503 may be displayed to be visually distinguished.

FIG. 5B illustrates a first device 507, a photographing area 505, and a virtual area 511. The first device 507 may be a smart phone and may include a touch screen. While a certain area is automatically set as the virtual area 511, when a user touches a screen using a finger 509 and moves the finger 509, a size of the virtual area 511 may change according to the movement of the finger. When a user releases the finger from a touch screen, the virtual area 511 may be set. The first device 507 may set the virtual area 511 based on a user input and transmit coordinate information corresponding to the virtual area 511 to the electronic device 403. In addition, the first device 507 may change the virtual area 511 based on the user input and transmit the coordinate information corresponding to the changed virtual area 511 to the electronic device 403.

FIG. 5C illustrates a photographing screen 521, a virtual area 525, a third object 527, and a fourth object 523. The third object 527 and the fourth object 523 may be obstacles that interfere with moving of the first object. An electronic device 403 may automatically set the virtual area 525 based on a screen photographed by the camera 401. For example, when a user enters a screen for setting a virtual area, the controller 101 may analyze a screen photographed by the camera 105, recognize the obstacles 523, 527 existing in the photographed screen, and set an area, excluding the obstacles 525 and 527, as the virtual area 525.

FIG. 5D illustrates a photographing screen 531 and a virtual area 533. The electronic device 403 may recognize an object from a screen photographed by the camera 403, and set the object as a virtual area. For example, when there is a carpet on a screen photographed by the camera 401, the electronic device 403 may set the carpet as the virtual area 533. The object that is set as the virtual area 533 may be determined by receiving information from a user in advance or by analyzing a photographing screen by the controller.

FIG. 5E illustrates a first device 541, a photographed screen 543, a third object 545, and the virtual area boundary line 549. The third object 545 may be an obstacle that interferes with moving the first object. The first device 541 may set a virtual area on a photographing screen based on user input that sets a virtual area on a screen displayed on a display. For example, when a user touches a photographing screen with a finger 547 and moves, a border line of the virtual area may be displayed on a screen according to traced movement of the finger, and the boundary line 549 may be set. The first device 541 may receive a coordinate of a touch point from the display and set up a virtual area based on the touch point.

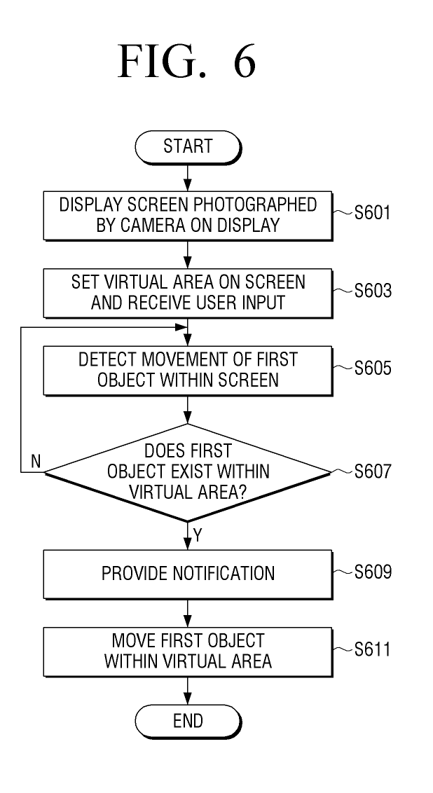

FIG. 6 is a flowchart illustrating a process for setting a virtual area in the electronic device and controlling movement of a first object, according to an embodiment of the present disclosure.

Referring to FIG. 6, the electronic device 100 displays a screen photographed by the camera 105 on the display 103, in step S601. The controller 101 may control the display 103 to display a screen photographed by the camera 105.

The electronic device 100 receives a user input to set a virtual area on a photographed screen, in step S603. The controller 101 may control the display 103 when a virtual area is set on a photographed screen, to visually distinguish the virtual area.

The electronic device 100 detects a movement of the first object 150 on a photographed screen, in step S605. The controller 101 may detect a movement of the first object 150 based on position information received from the first object 150. Alternatively, the controller 101 may detect a movement of the first object 150 by analyzing a photographed screen. For example, the controller 101 may calculate a motion vector of the first object 150 by processing a video signal of the photographed screen and detect a movement of the first object 150 based on the motion vector.

The electronic device 100 determines whether the first object 150 exists in the virtual area, in step S607. When the first object does not exist within the virtual area, the methodology returns to step S605 to detect the movement of the first object.

The electronic device 100 provides a notification, when the first object 150 exists within the virtual area, in step S609. Alternatively, the electronic device 100 may provide a notification if the first object 150 is outside of the virtual area. The notification may be a message displayed on a screen, a voice message, or vibration feedback.

The electronic device 100 moves the first object 150 within the virtual area, in step S611. The controller 101 may transmit coordinate data to the first object 150 with respect to a position within the virtual area, and control the first object 150 so that the first object 150 exists within the virtual area. The first object 150 may receive coordinate data from the electronic device 100, and control the driver 155 of the first object 150 so that the first object 150 moves within the virtual area based on the received data.

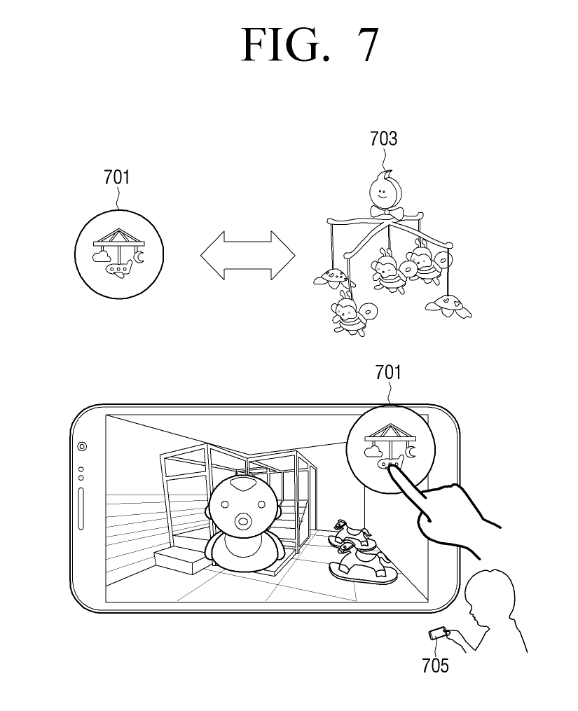

FIG. 7 is a diagram illustrating an identification of a first object on a screen photographed by a camera and movement of the first object according to a user input, according to an embodiment of the present disclosure.

FIG. 7 illustrates an icon 701, a first object 703, and a first device 705. The icon 701 may be made using the first object 703 included in a photographed screen. When a user presses or touch the icon 701, the first object 703 may be operated. For example, when a mobile is displayed on a photographed screen, the first device 705 may extract a graphic object corresponding to the mobile and make the graphic object the icon 701.

The first device 705 may generate the icon 701 by capturing a part of the area of the photographed screen, display the generated icon 701 to overlap the photographed screen, and, in response to a user input selecting the icon 701, may control the first object 703 to correspond to the icon 701.

Alternatively, the first device 705 may identify the first object 703 on a screen photographed by the camera, and generate the icon 701 by using an image corresponding to the first object 703. The first device 705 may display the generated icon 701 overlapped with the photographed screen, and in response to a user input to select the icon 701, may control the first object 703 corresponding to the icon 701. The first device 705, when a user input is detected from the icon 701, may transmit a command to move the first object 703. The first object 703 may receive a command transferred from the first device 705 and move the first object 703.

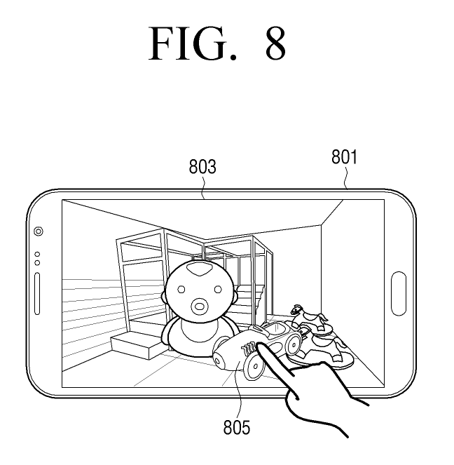

FIG. 8 is a diagram illustrating an identification of a first object on a screen photographed by a camera and movement a first object according to a user input, according to an embodiment of the present disclosure.

FIG. 8 illustrates an electronic device 801, a photographed screen 803, and a first object 805. The electronic device 801 may be a smart phone and may include a camera and a touch screen. The screen 803 photographed by the camera may be displayed on a touch screen. The electronic device 801 may identify the first object 805 on the photographed screen 803. A method for identifying the first object 805 is the same as the method described above with respect to FIG. 3A. A user input may be detected on the first object 805 displayed on a screen. The electronic device 801 may control the first object 805 to operate in response to the user input. For example, when a user touches the first object 805 on the photographed screen 803 displayed on the touch screen, the electronic device 801 may move the first object 805. The electronic device 801 may transmit an operation command of the first object 895 and operate the first object 805.

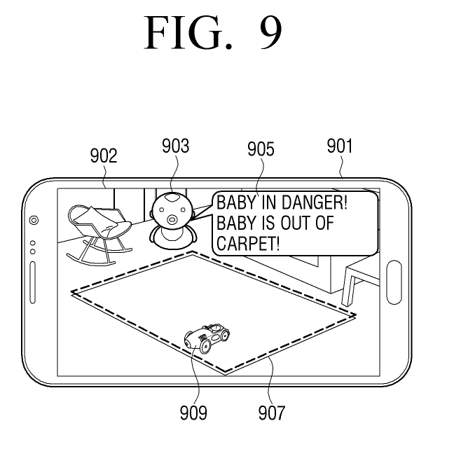

FIG. 9 is a diagram illustrating the display of a notification in the electronic device when a first object or a second object is out of a virtual area on a screen photographed by a camera, according to an embodiment of the present disclosure.

FIG. 9 illustrates an electronic device 901, a photographed screen 902, a first object 909, a second object 903, a virtual area 907, and a notification message 905.

The electronic device 901 may be a smart phone and include a camera and a touch screen. The electronic device 901 may recognize a specific object on a photographed screen 902 and set the virtual area 907. For example, when there is a carpet on the photographed screen 902, the electronic device 901 may set the carpet as the virtual area 907.

The first object 909 may be, for example, an electronic toy that can move through the control of the electronic device 901. The second object 903 may be, for example, a baby. The second object 903 may communicate with the electronic device 901 using a communication patch, and may transmit position information to the electronic device 901 on a real-time basis.

When the second object 903 is outside of the virtual area 907, the electronic device 901 may display the notification message 905 on the touch screen. The electronic device 901 may display a message corresponding to the subject on a screen, based on a position of the subject. The subject may the first object 909 or the second object 903. For example, when the second object 903 exists outside of the virtual area 907, the electronic device 901 may control the touch screen to display the notification message 905 on the screen. In addition, the electronic device 901 may output a preset message as a sound or may provide vibration feedback corresponding to a set message.

Additionally, the electronic device 901 may send an operation command to the first object 909 so that the first object 909 can operate. If the second object 903 moves within the virtual area 907, the electronic device 901 may stop a movement of the first object 909. For example, if the first object 903 is outside the virtual area 907 on the photographing screen 902, the electronic device 901 may display a message on the touch screen, control the second object 909 to operate, and when it is determined that the first object 903 moves within the virtual area, stop operation of the second object 909. Alternatively, if the first object 903 approaches the second object 909, the electronic device 901 may control the second object to move to another space.

Additionally, the electronic device 901 may receive a message transmitted from a TV embedded with, for example, a camera, and display the received message on the screen 902. In this case, when a TV receives a screen photographed by a camera, and the second object 909 is outside of the virtual area, the preset message can be transmitted to the electronic device. In addition, a TV may output a message as sound through a speaker mounted in the TV.

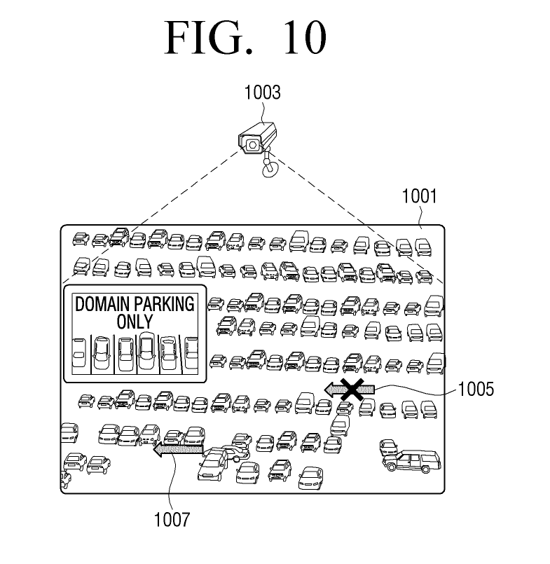

FIG. 10 is a diagram illustrating surveillance in a parking lot, according to an embodiment of the present disclosure.

Referring to FIG. 10, a camera 1003, a screen 1001 photographed by the camera, and messages 1005 and 1007 are illustrated. The messages 1005, 1007 can be a graphic object or a text.

In a parking lot, a parking line may be drawn, and a vehicle can be parked inside the parking line. The camera 1003 may photograph a parking lot and may transmit the photographed screen 1001 to the electronic device 100. The electronic device 100, for example, may be computer. The electronic device 100 may analyze the photographed screen and identify a state of a parked vehicle inside each parking line. The parking line may be a virtual area. The vehicle may be a first object.

When the first object is inside the virtual area, the electronic device 100 may display the first message 1007 on a screen. When the first object is outside of the virtual area, the electronic device 100 may display the second message 1005 on a screen. The first message 1007 may be provided as visual information, auditory information, or tactile information. The second message 1005 may be provided as visual information, auditory information, or tactile information.

For example, when a vehicle is inside a parking line, the electronic device 100 may display the first message 1007, and when a vehicle is outside of the parking line, the electronic device 100 may display the second message 1005. In addition, even when there is an empty space, the first message 1007 can be displayed. The first message 1007 may indicate that there is an empty space in a proceeding direction of a vehicle, a message indicating that entering is possible, or a voice message. In addition, when there is no empty space, the electronic device 100 may display the second message 1005. The second message 1005 may indicate that there is no empty space in a proceeding direction of a vehicle or may indicate that entering is not possible, or may be a voice message. The first message 1007 and the second message 1005 may be provided as a graphic object and/or text.

The electronic device 100 may display the first message 1007 on a first position of the photographed screen. The electronic device 100 may display the second message 1005 on a second position of the photographed screen. The first position may be a position of a point that the first object is at inside the virtual area. The second position may be a position that the first object is outside of the virtual area.

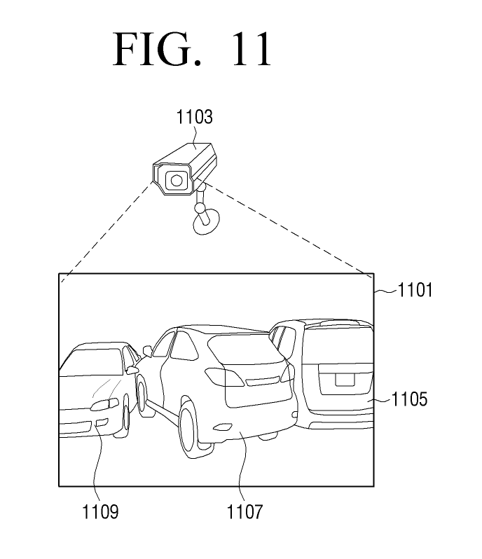

FIG. 11 is a diagram illustrating surveillance in a parking lot, according to another embodiment of the present disclosure.

FIG. 11 illustrates a camera 1103, a photographed screen 1101, and objects 1105, 1107, 1109.

The electronic device 100 may receive a screen photographed by the camera 1103, and display the received photographed screen 1101 on a display. The electronic device 100 may identify a virtual area on the photographed screen 1101, determine whether there is an object 1105, 1107, 1109 inside the virtual area, and provide a message based on a determination result. A virtual area may be inside the parking line. The objects 1105, 1107, 1109 may be parked vehicles. For example, when the vehicles 1105, 1107, 1109 are parked on a parking line and vehicle 1107 is out of a parking line, the electronic device 100 may provide a preset message. Each message can be provided as visual, auditory, or tactile information. In addition, when a parked vehicle collides with another vehicle, the electronic device 100 may provide a message. Further, when a vehicle that is parked is not a pre-registered vehicle, the electronic device 100 may provide a message by identifying a license plate of the vehicle.

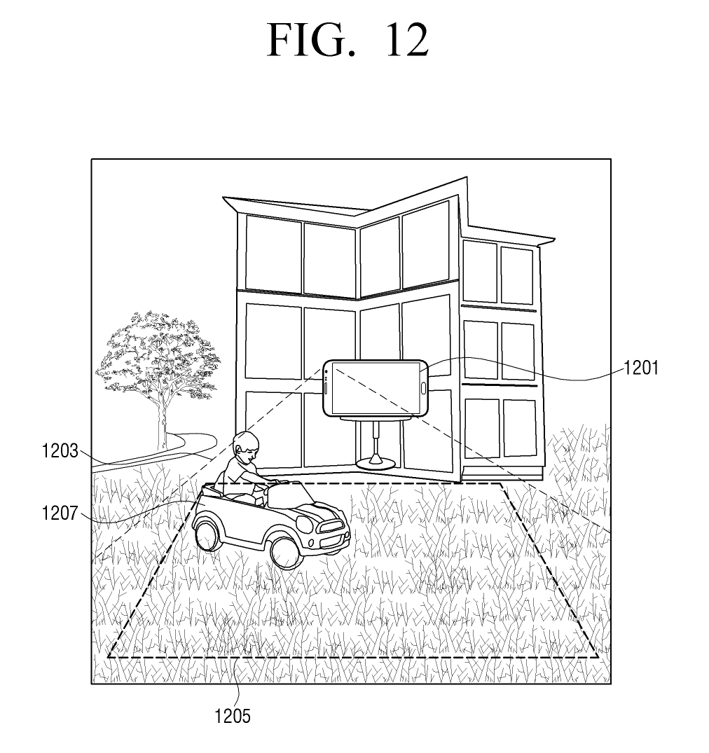

FIG. 12 is a diagram illustrating movement of a first object according to user input, according to another embodiment of the present disclosure.

FIG. 12 illustrates an electronic device 1201, a photographing area 1203, a virtual area 1205, and a first object 1207. The electronic device 1201 may be a smartphone of a user. The first object 1207 may be a device that can move through control of a device.

The electronic device 1201 may display a screen photographed by a camera on a touch screen, receive a user input to set the virtual area 1205 on the touch screen, and control the movement of the first object 1207 based on a user input. In addition, the controller may analyze a photographed screen and automatically set a virtual area, and the photographed screen may not be displayed on a touch screen.

The electronic device 1201 may control the first object 1207 to move only within the virtual area 1205. Additionally, when the first object 1207 moves to outside of the virtual area 1205, the electronic device 1201 may provide a notification message and control the first object 1207 so that the first object 1207 moves within the virtual area 1205. The notification message can be provided as one or more of visual, auditory, and tactile information.

For example, the first object 1207 may be a toy on which a human can ride. Through the control of the electronic device 1201, the first object 1207 can move within the virtual area 1205. When a parent photographs, a vacant lot and sets the virtual area 1205 with a smart phone, the first object 1207 can move only within the virtual area 1205, and children playing outside the building can be monitored. When the first object 1207 moves outside the virtual area 1205, a notification message may be displayed on a touch screen of the smart phone, or a notification message can be provided by sound or vibration feedback.

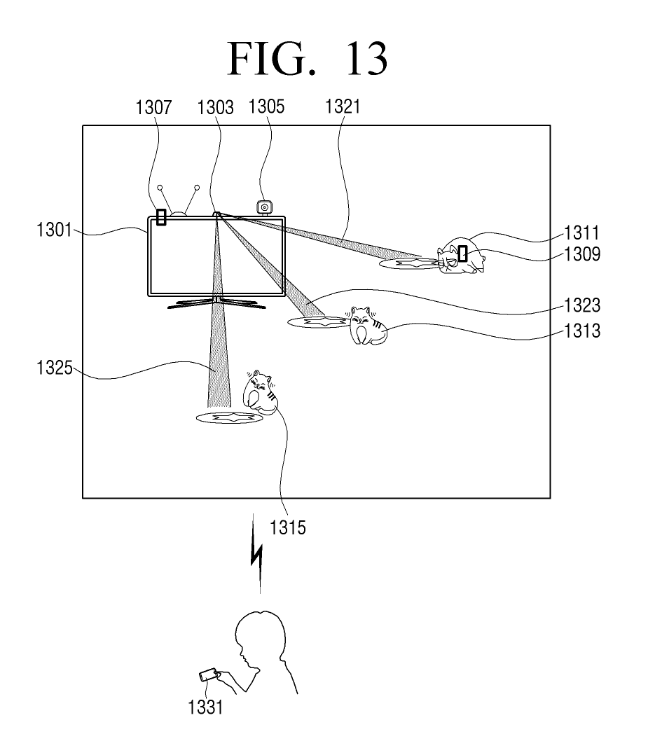

FIG. 13 is a diagram illustrating surveillance, according to an embodiment of the present disclosure.

FIG. 13 illustrates an electronic device 1301, a beam generator 1303, a camera 1305, an infrared receiver 1307, an infrared transmitter 1309, and a first device 1331. The electronic device may be TV. The light generator 1303 may emit laser light to a desired position through the control of the electronic device 1301. The camera 1305 may photograph a subject and transmit the same to the electronic device 1301. The infrared receiver 1307 may receive infrared rays transmitted from the infrared transmitter 1309 attached to the subject, change it to an electrical signal, and transmit the same to the electronic device 1301. The infrared transmitter 1309 may be attached to a subject in a form of a patch, and may emit infrared rays. The subject can be a pet. An infrared ray transmitter can be attached to provide position information. When a subject moves, infrared rays can be emitted from a new position. The electronic device 1301 may determine a position of a subject from the infrared signal of the subject received through the infrared receiver 1307. In addition, the electronic device may determine a position of the subject by analyzing the photographed screen.

The light generator 1303, the camera 1305, and the infrared receiver 1307 can be provided inside the electronic device 1301 or can be provided as a separate accessory. The first device 1331 may be a smart phone, and a user may view a screen photographed by the camera 130 remotely using a smart phone. In addition, a user may control the light generator 1303 using a smart phone.

The electronic device 1301 may determine the position of the subject in a screen based on the signal received through the infrared receiver 1307. The electronic device 1301 may control the light generator 1303 based on the signal received from the first device 1331. The received signal may be a signal sent to the electronic device 1301, in response to a user input from the first device 1331. For example, when the user touches a position 1311 in the screen displayed in the smart phone, the light generator 1303 may transmit a laser beam 1321 to the position 1311. When the user touches a position 1313 in the screen displayed in the smart phone, the light generator 1303 may transmit a laser beam 1323 to the position 1313. When the user touches a position 1315 in the screen displayed in the smart phone, the light generator 1303 it may transmit a laser beam 1325 to the position 1315. A subject can be moved in accordance with the changed position of laser light.

Additionally, when a user sets a virtual area using a smart phone, the electronic device 1301 may control the light generator 1303 based on the virtual area. That is, the electronic device 1301 may control the light generator 1303 so that laser light is not out of the virtual area.

The non-transitory computer-recordable medium is not a medium configured to temporarily store data such as a register, a cache, or a memory, but an apparatus-readable medium configured to semi-permanently store data. Specifically, the above-described various applications or programs may be stored in a non-transitory apparatus-readable medium such as a compact disc (CD), a digital versatile disc (DVD), a hard disc, a Blu-ray disc, a universal serial bus (USB), a memory card, or a read only memory (ROM), and then may be provided to a user terminal device.

While the present disclosure has been shown and described with reference to certain embodiments thereof, it will be understood by those skilled in the art that various changes in form and detail may be made therein without departing from the spirit and scope of the disclosure as defined by the appended claims.

What is claimed is:

1. An electronic device comprising:
a display configured to display a screen photographed by a camera; and
a controller configured to receive a user input, set a virtual area on the screen based on the user input, identify a first object on the screen, and control the first object to move within the virtual area.

2. The electronic device as claimed in claim 1, wherein the controller is further configured to identify a second object on the screen, and provide a notification when the second object is outside of the virtual area.

3. The electronic device as claimed in claim 1, wherein the electronic device further comprises:
a communicator configured to communicate with the first object,
wherein the electronic device determines a position of the first object based on a signal received from the first object.

4. The electronic device as claimed in claim 1, wherein the camera exists outside of the electronic device and is electrically connected to the electronic device.

5. The electronic device as claimed in claim 1, wherein the controller is further configured to transmit the screen to an external device.

6. The electronic device as claimed in claim 5, wherein the controller is further configured to set the virtual area based on a signal received from the external device.

7. The electronic device as claimed in claim 5, wherein the controller is further configured to control movement of the first object based on a signal received from the external device.

8. The electronic device as claimed in claim 1, wherein the controller is further configured to control the display to visually distinguish and display the virtual area on the screen.

9. The electronic device as claimed in claim 1, wherein the controller is further configured to analyze the screen and sense movement of the first object.

10. The electronic device as claimed in claim 1, wherein the controller is further configured to control the first object to move within the virtual area in response to an indication that the first object is outside of the virtual area.

11. A method for controlling movement of a first object, the method comprising:
displaying a screen photographed by a camera on a display of an electronic device;
setting a virtual area on the screen based on user input;
identifying a first object on the screen; and
controlling the first object to move within the virtual area.

12. The method as claimed in claim 11, further comprising:
identifying a second object on the screen; and
providing a notification when the second object is outside of the virtual area.

13. The method as claimed in claim 11, further comprising:
determining a position of the first object based on a signal received from the first object.

14. The method as claimed in claim 11, further comprising:
transmitting the screen to an external device.

15. The method as claimed in claim 11, further comprising:
receiving a signal from an external device; and
setting the virtual area based on a signal received from the external device.

16. The method as claimed in claim 15, further comprising:
controlling movement of the first object based on a signal received from the external device.

17. The method as claimed in claim 11, further comprising:
visually distinguishing and displaying the virtual area on the screen.

18. The method as claimed in claim 11, further comprising:
analyzing the screen and sensing movement of the first object.

19. The method as claimed in claim 11, further comprising:
controlling the first object to move within the virtual area in response to an indication that the first object is outside of the virtual area.

20. An electronic device comprising:
a camera; and
a controller configured to analyze a screen photographed by the camera, determine a virtual area on the screen, identify a first object on the screen, and control the first object to move within the virtual area.
